(19) United States
(12) Patent Application Publication
(10) Pub. No.: US 2011/0303765 A1
(43) Pub. Date: Dec. 15, 2011

(54) HIGH VOLUME LOW PRESSURE PAINT SPRAYER

(75) Inventor: Ruth Elizabeth Walcot, Cambridge (GB)

(73) Assignee: Akzo Nobel Coatings International B.V., Arnhem (NL)

(21) Appl. No.: 13/139,581

(22) PCT Filed: Dec. 22, 2009
(86) PCT No.: PCT/EP2009/067769

§ 371 Date: Aug. 30, 2011

(30) Foreign Application Priority Data
Dec. 22, 2008 (GB) 0823373.6

(51) Int. Cl. B05B 11/04

(52) U.S. Cl. 239/328; 239/589

(57) ABSTRACT

A high volume low pressure paint sprayer comprising a paint spray gun and a releasable paint canister, in which the paint canister has an integrated paint spray nozzle.

The present invention relates to a high volume low pressure (HVLP) paint sprayer.

Known HVLP paint sprayers comprise a paint gun having an integral paint spray nozzle that is fluidly connected to a container which typically screws onto, and is situated below the paint gun. The container is removed to allow paint to be decanted into it. The paint gun is supplied with air from a fan, which forces paint from the container towards the paint spray nozzle from where it is propelled towards a target surface.

In HVLP sprayers, the HV refers to the high volume air flow which is typically in the range 6 to 20 m³/hr. LP refers to the low pressure supply which is less than 0.5 bar, typically in the range 0.1-0.2 bar. The low pressure supply results in less overspray, which enables the sprayer to be used in confined areas, for example, the interior of buildings.

One problem associated with known HVLP sprayers relates to the fact that the paint spray nozzle is integral with the paint gun itself, and therefore the spray nozzle requires cleaning after use to prevent contamination when a different paint colour is used, or in the worst case, causes blockage of the nozzle.

A further problem is that the removable container also needs to be cleaned after use, so as to prevent contamination with a different paint of a different colour.

According to the present invention there is provided a high volume low pressure paint sprayer comprising a paint spray gun and a releasable paint canister, in which the paint canister has an integrated paint spray nozzle.

Advantageously, integrating the paint spray nozzle and paint canister prevents other parts of the paint sprayer becoming contaminated with paint. The paint canister can be provided as a disposable assembly which eliminates the risk of cross contamination with paint as is the case with known HVLP sprayers where the canister and nozzle are re-used.

This contrasts with known HVLP sprayers which do not have releasable canisters with an integrated nozzle, the nozzle being part of the spray gun which is easily contaminated with paint and requiring cleaning when a different colour paint is used or when a painting job has been completed.

According to another aspect of the present invention there is provided a high volume low pressure paint sprayer comprising a paint spray gun, a paint canister, and an air supply, the paint canister has a nozzle with a paint outlet, in which the air supply to the paint canister causes paint to flow from the paint canister via the paint outlet, in which the paint outlet is permanently open.

By permanently open it is meant a paint outlet with no valve to restrict the flow of paint. This is advantageous as it is one less moveable part that requires cleaning, and can block to inhibit paint flow. Such a valve is required for canisters that are pre-pressurised to prevent the paint from flowing.

According to another aspect of the present invention there is provided a high volume low pressure paint sprayer comprising a paint spray gun, a paint canister, and an air supply, the paint canister has a nozzle with a paint outlet, the paint canister comprising a rigid outer container defining a second air chamber, and a flexible bag defining a paint chamber containing paint, in which the flexible bag is fluidly connected to the paint outlet such that the air supply to the second air chamber causes the flexible bag to deform and force paint towards the paint outlet.

This is advantageous because firstly the air flow rate determines the paint flow rate, which negates the need for a valve in the paint nozzle, and secondly, the use of a deformable bag inside a rigid container enables the spray gun to be used at any angle which contrasts to known HVLP sprayers which require the spray gun to remain substantially uprights as they are principally gravity fed.

Preferably the paint canister includes a rigid internal collar which locates inside the flexible bag and extends away from an opening of the bag a distance sufficient to prevent the base of the flexible bag from collapsing when the bag deforms.

This is advantageous since the controlled collapse of the bag maintains a constant paint flow rate which reduces spattering.

The rigid internal collar typically has length between 10 to 50% of the length of the flexible bag (including the collar located inside).

According to another aspect of the present invention there is provided a high volume low pressure paint sprayer including a nozzle with a paint outlet, and an atomising air outlet which partially surrounds the paint outlet, the paint outlet has a paint flow face, and the air outlet has an air flow face, in which the air flow face is vertically above and offset from the paint flow face.

Advantageously, spacing the paint flow face from the air flow face increases the atomisation of the paint.

Preferably the air flow face has a partially circular profile, for example, a radiused profile.

This is advantageous since it contributes to the increased atomisation of the paint.

According to another aspect of the present invention there is provided a high volume low pressure paint sprayer comprising a paint spray gun, a paint canister, and an air supply, the paint canister has a nozzle with a paint outlet, in which the air supply to the paint canister causes paint to flow from the paint canister via the paint outlet, and supplies air to an atomising air outlet which least partially surrounds the paint outlet so as to at least partially atomise the paint being propelled from the paint outlet.

This is advantageous since one air supply causes paint flow and atomises the paint.

Preferably the air supply is coupled releasably coupled to an air manifold which is attached to the paint canister, the air manifold having a first air inlet which supplies air to the atomising air outlet, and second air inlet, which supplies air to the paint canister to cause the paint to flow.

Preferably the air manifold is releasably attachable to the paint canister.

This is advantageous since it allows interchangeable air manifolds with different air flow characteristics.

According to another aspect of the present invention there is provided a high volume low pressure paint sprayer comprising a paint spray gun, a paint canister having a flexible bag with a base, and an air supply, the paint canister has a nozzle with a paint outlet, the paint canister has an upper end located proximate an air manifold, and a lower end proximate the base of the flexible bag, in which the air supply to the paint canister is fed to the upper end of the paint canister, preferably to the air manifold.

This is advantageous since the air supply is fed downwards towards the base of the paint canister and fills the paint canister with air from above the base, which allows the bag to deform in a controlled way when compared to a canister that is fed from below the base.

The invention will now be described with reference to the accompanying drawings in which:

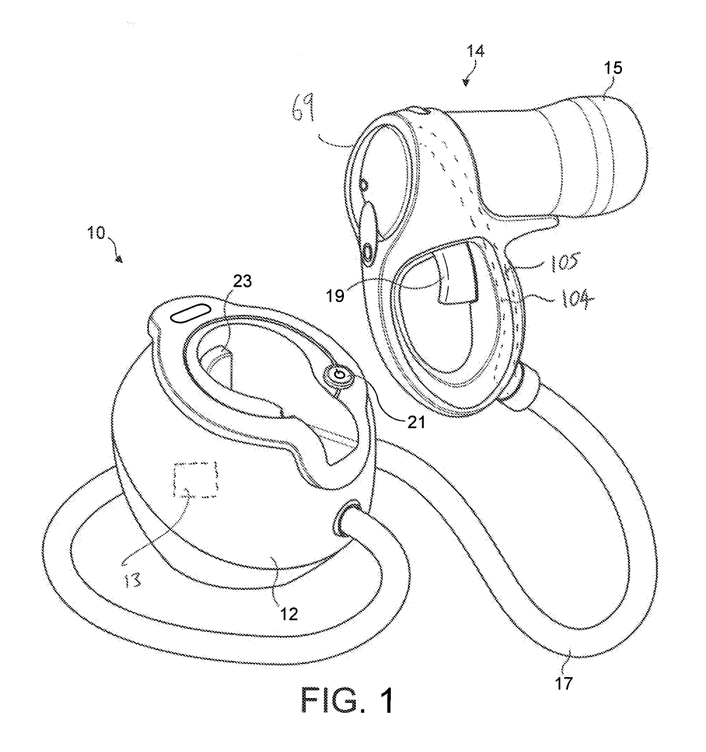

FIG. 1 is a perspective view of a high volume low pressure paint (HVLP) sprayer according to the present invention,

FIG. 1A is a perspective view of part of the sprayer of FIG. 1,

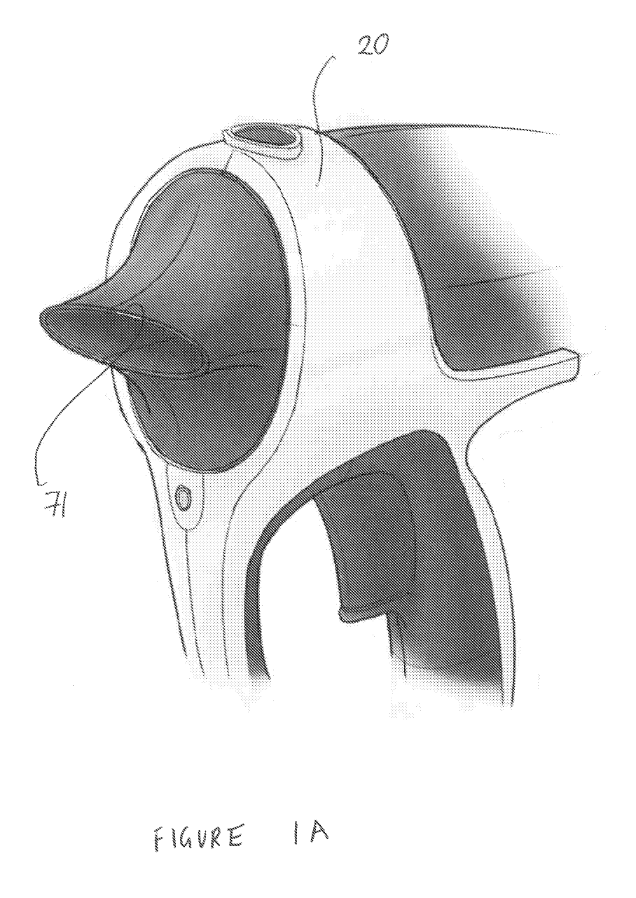

FIG. 2 is a perspective view of part of the sprayer of FIG. 1,

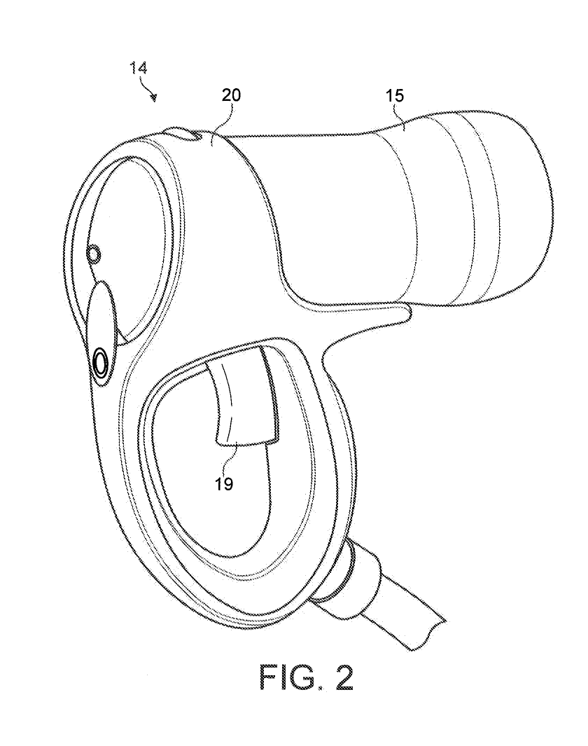

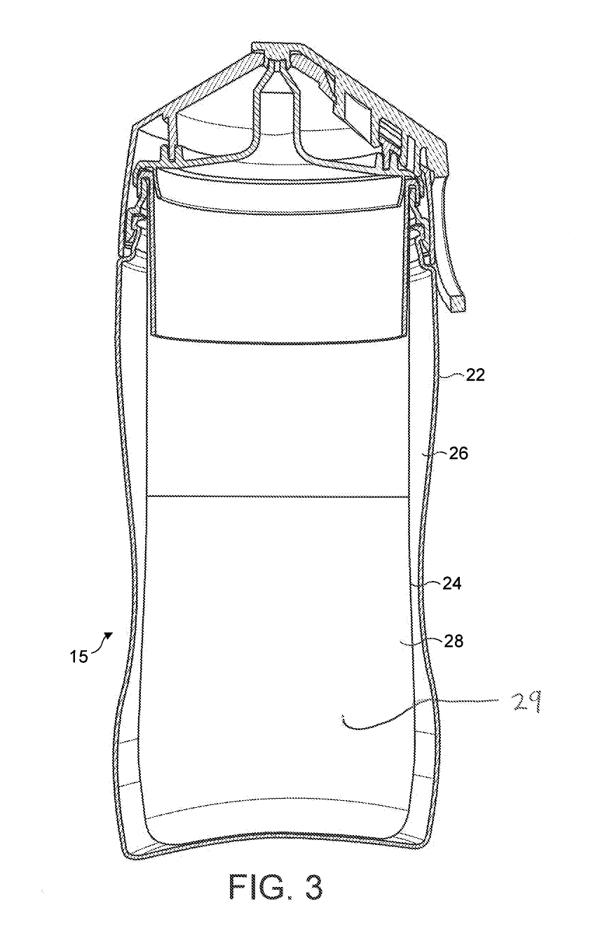

FIGS. 3 and 4 are front sectional views of part of the sprayer of FIG. 1,

FIG. 4A is a schematic view showing part of the sprayer of FIG. 1,

FIGS. 4B to 4D are sectional views of part of the sprayer of FIG. 1,

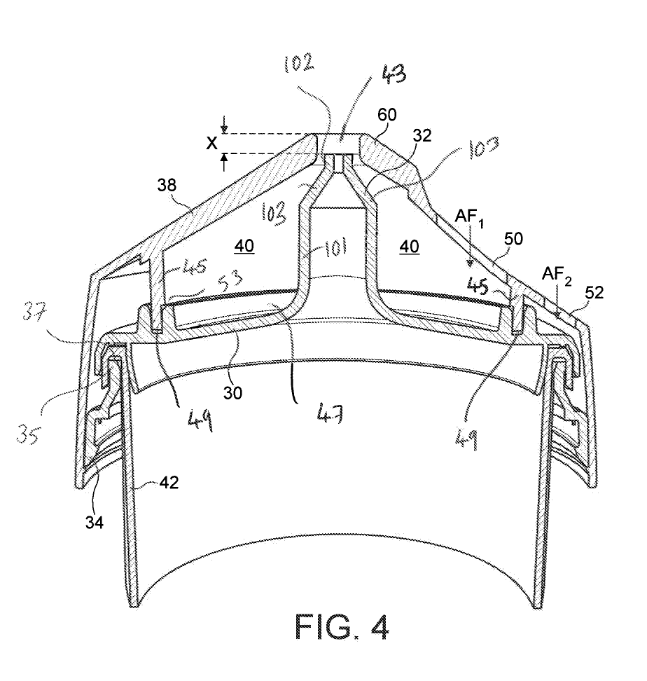

FIG. 5 is a perspective view of part of the sprayer of FIG. 1,

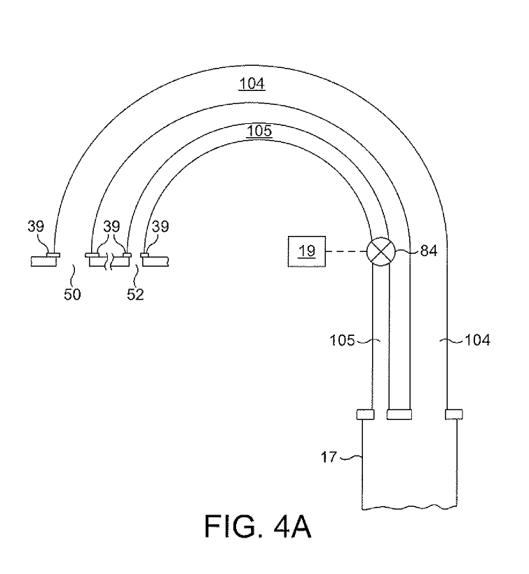

FIG. 6 is a front sectional view of part of the sprayer of FIG. 1,

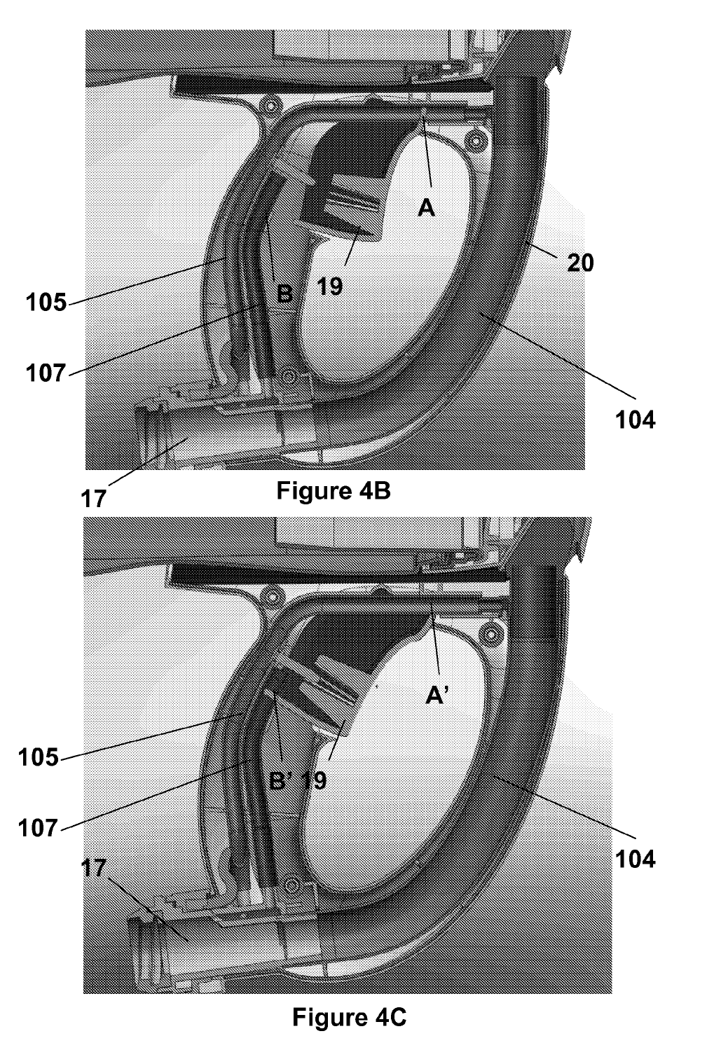

FIGS. 7 to 13 are front sectional views of part of the sprayer of FIG. 1,

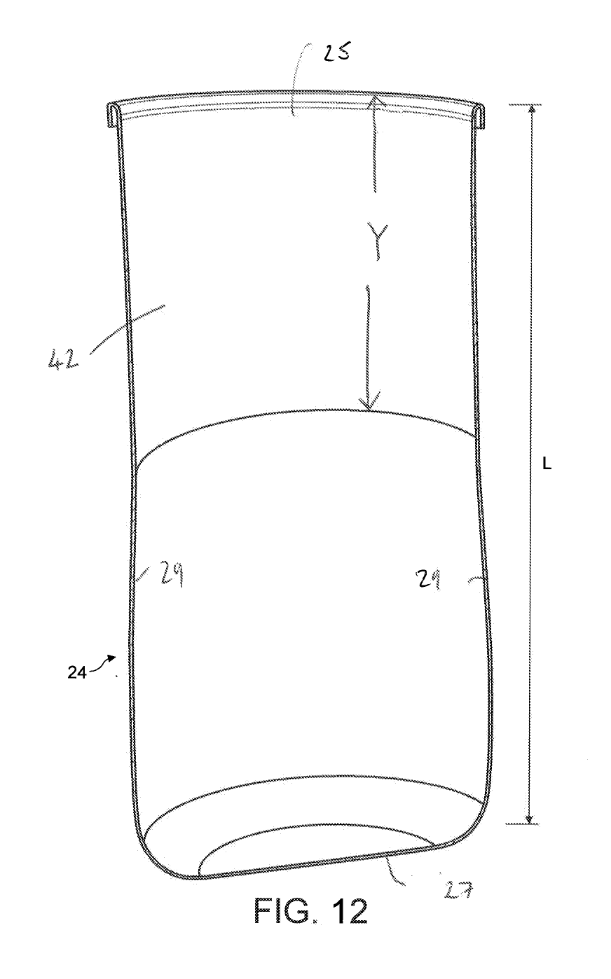

FIG. 14 is a perspective view of part of the sprayer of FIG. 1,

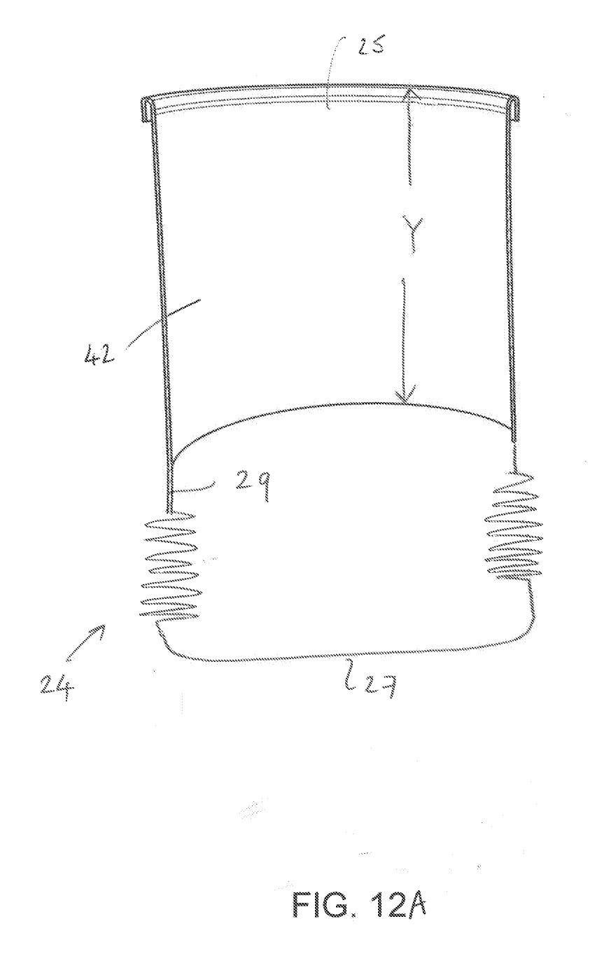

FIG. 15 is a sectional view of part of an alternative sprayer,

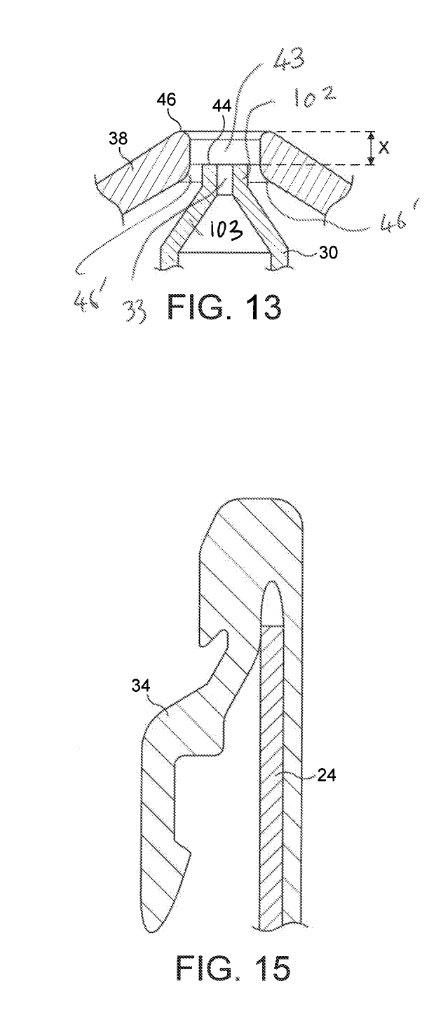

FIG. 16 is a perspective view of part of the sprayer of FIG. 1,

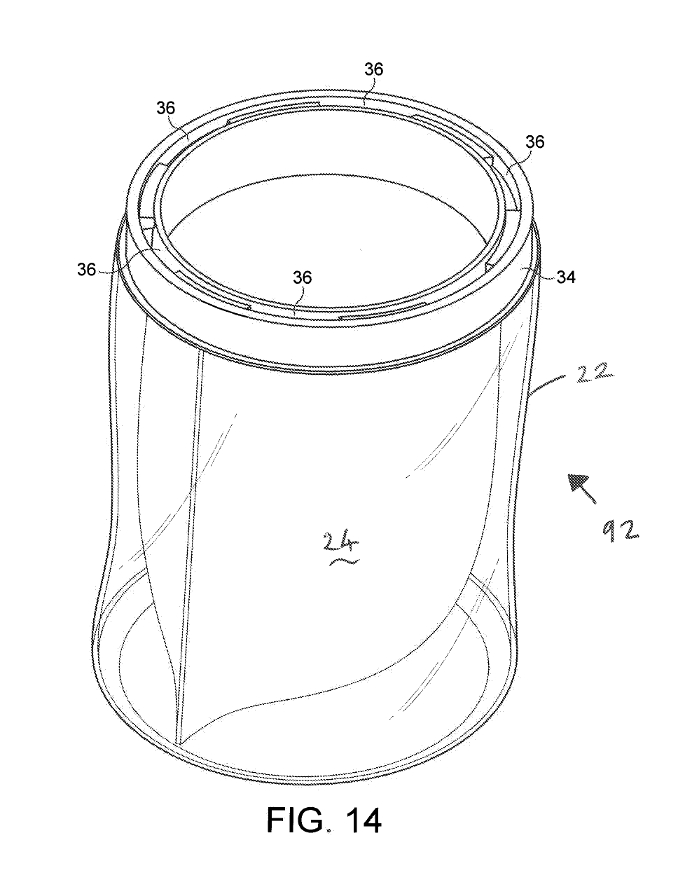

FIG. 17 is a front sectional view of part of the sprayer of FIG. 1,

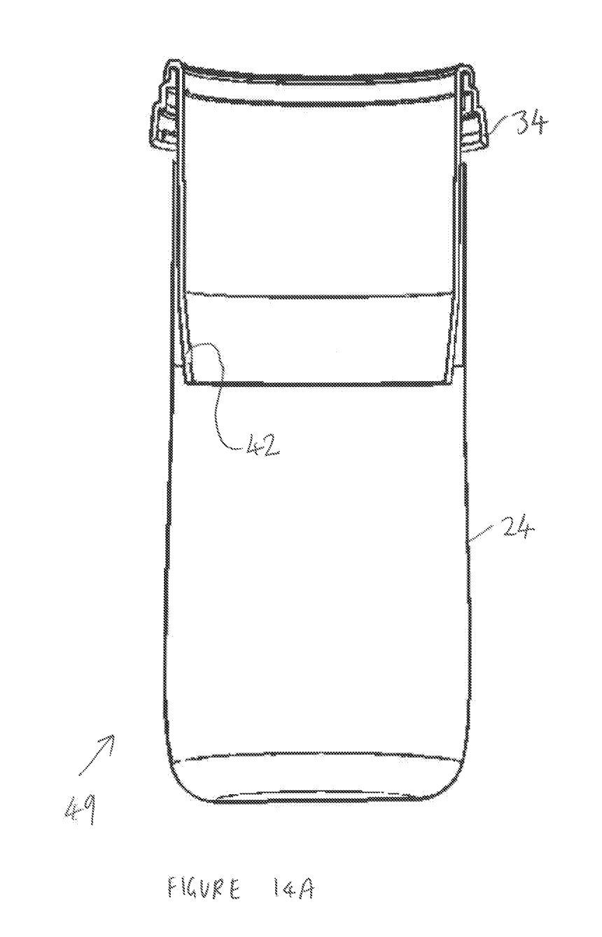

FIG. 18 is a sectional perspective view of part of the sprayer of FIG. 1,

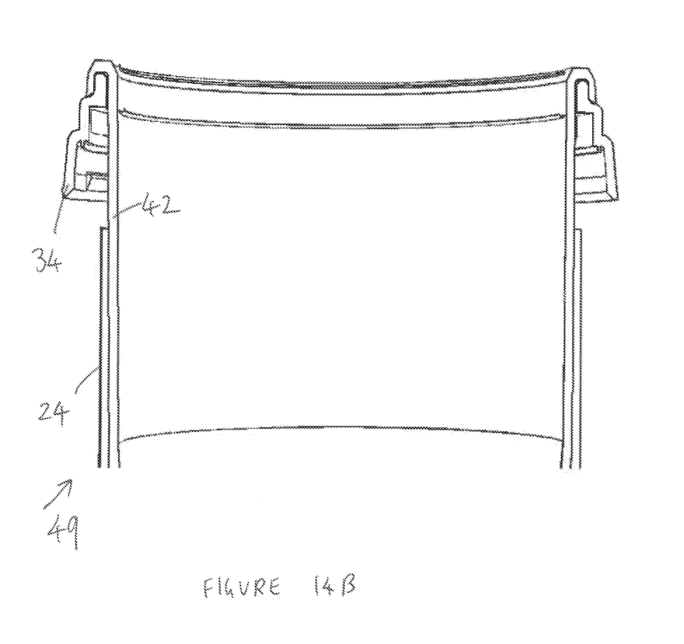

FIG. 19 is a front sectional view of part of the sprayer of FIG. 1,

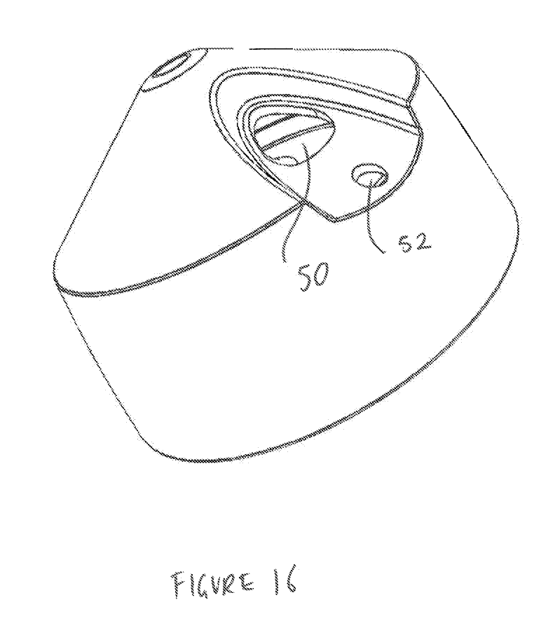

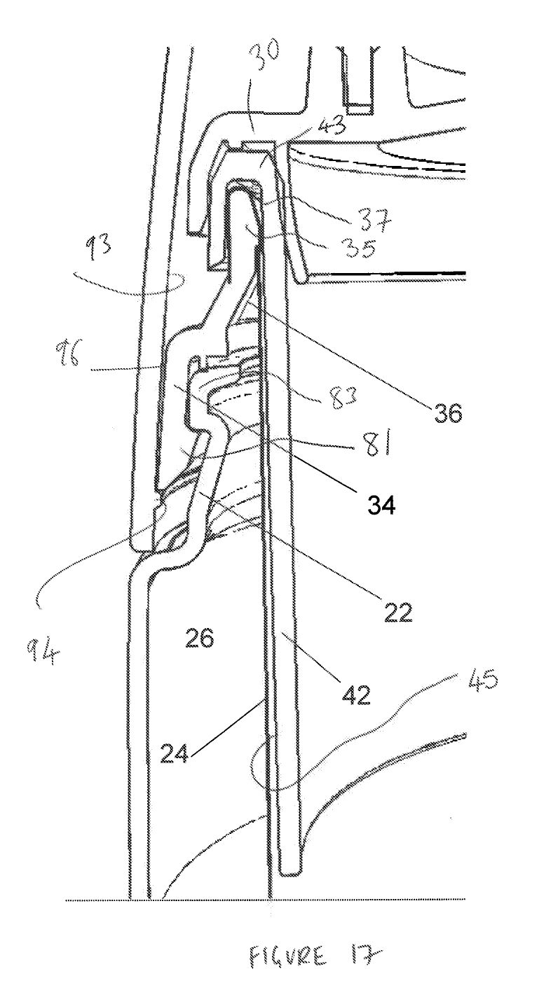

FIGS. 20 to 22 are plan views of part of the sprayer of FIG. 1,

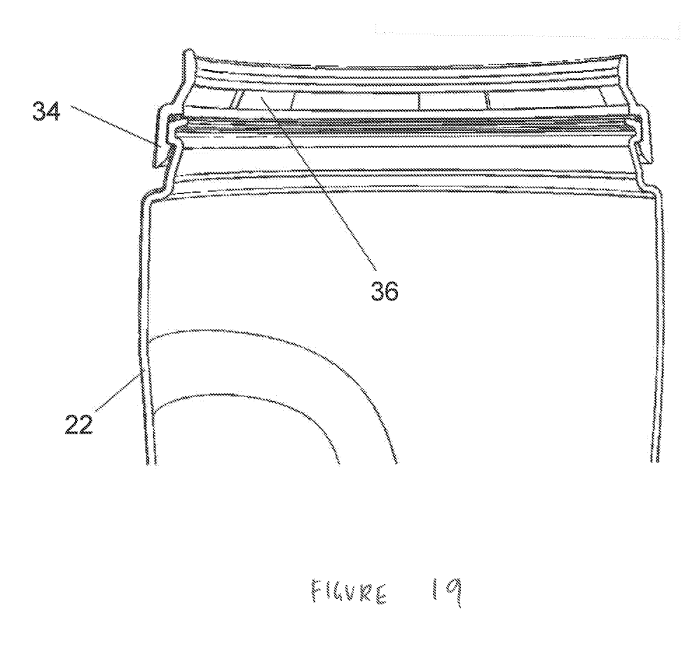

FIG. 23 is a front schematic view of the sprayer of FIG. 1,

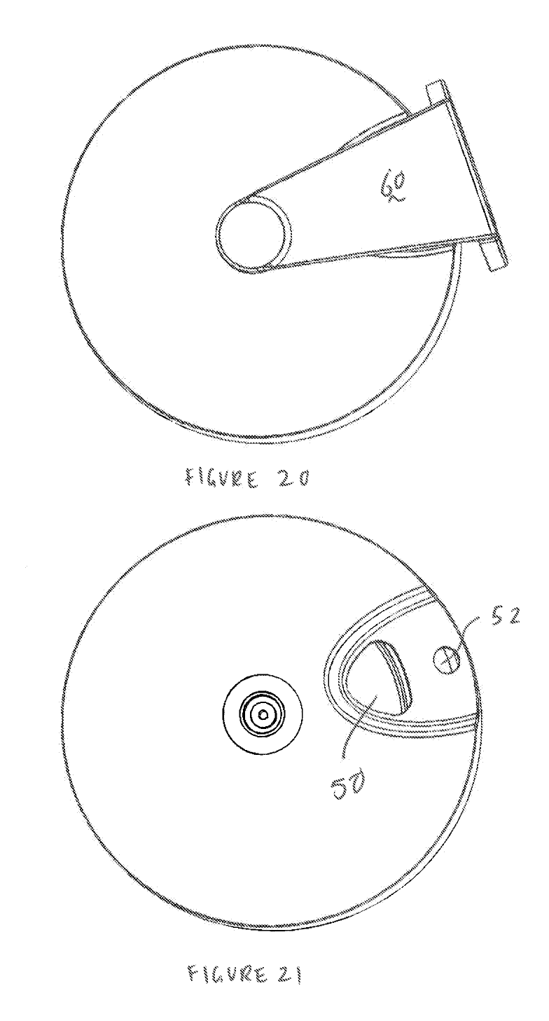

FIG. 24 is a perspective view of part of the an alternative sprayer,

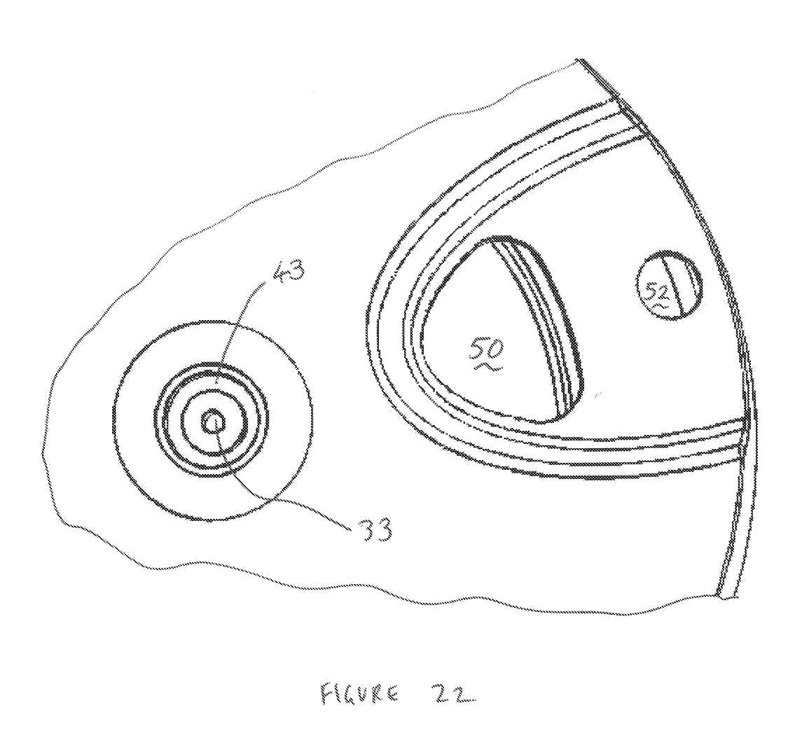

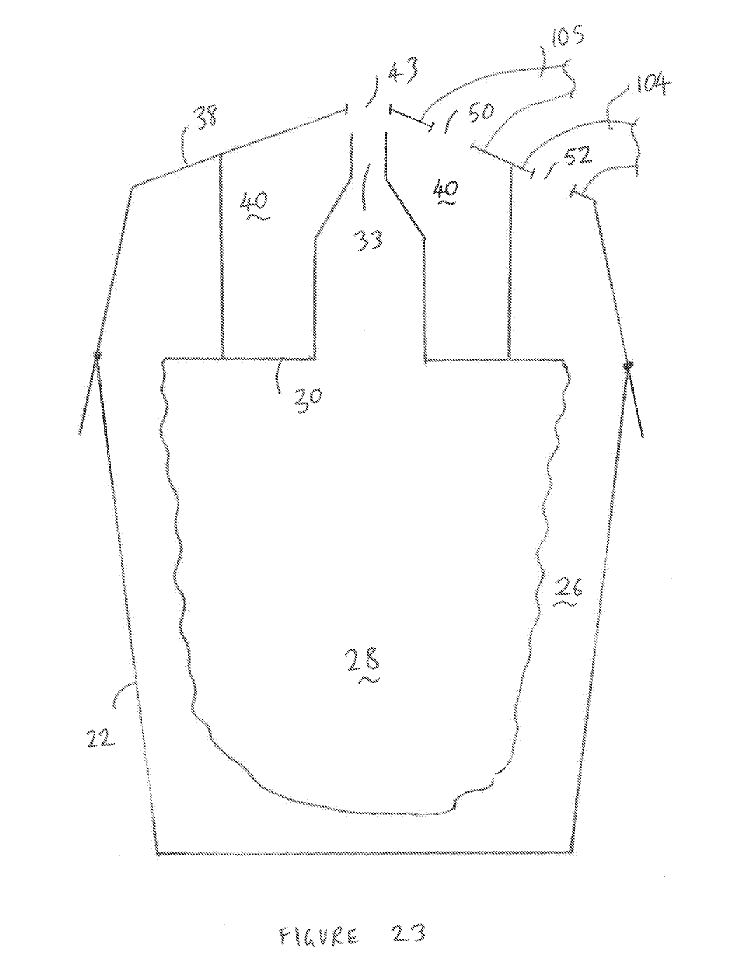

FIGS. 25 and 26 are front sectional views of part of the sprayer of FIG. 24,

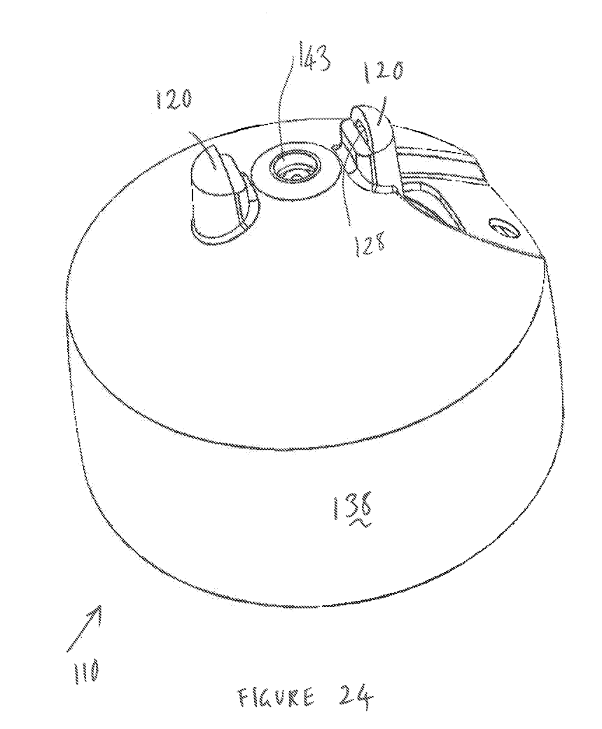

FIG. 27 is a perspective view of part of the sprayer of FIG. 24

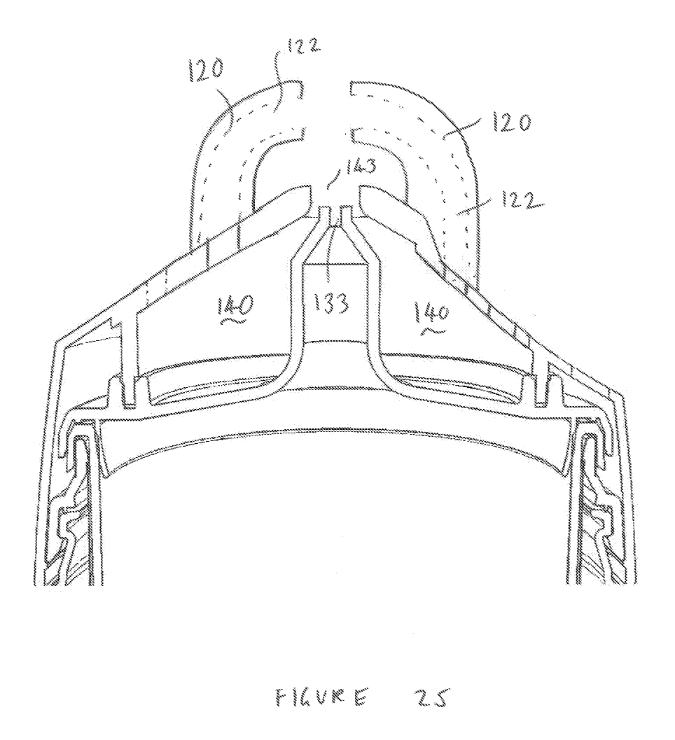

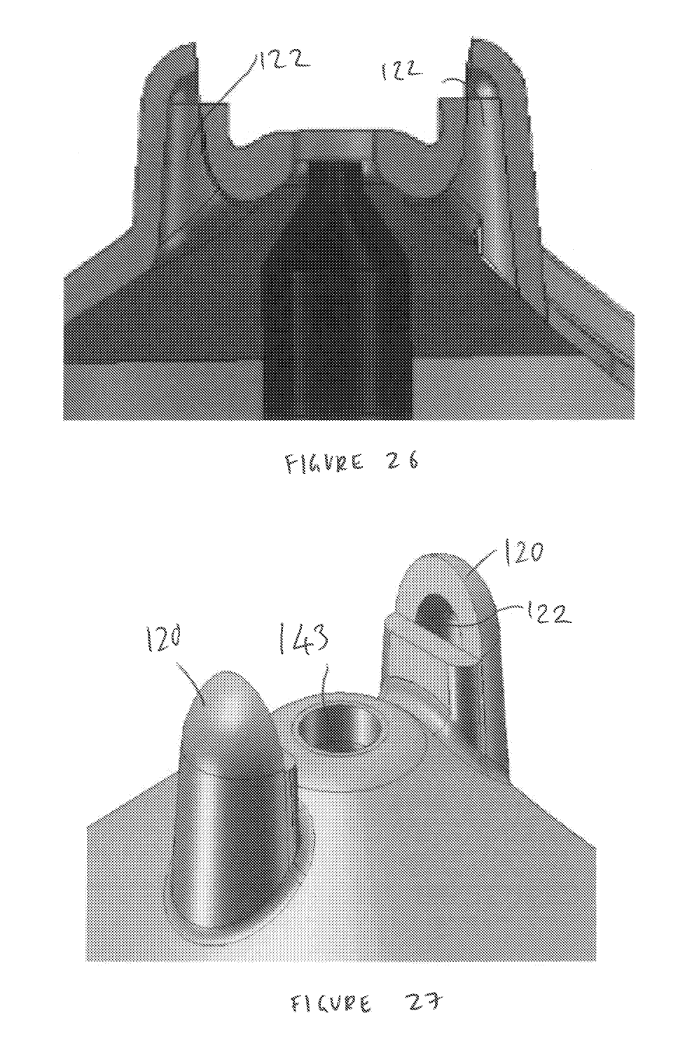

FIGS. 28 and 29 are front sectional views of part of the sprayer of FIG. 24,

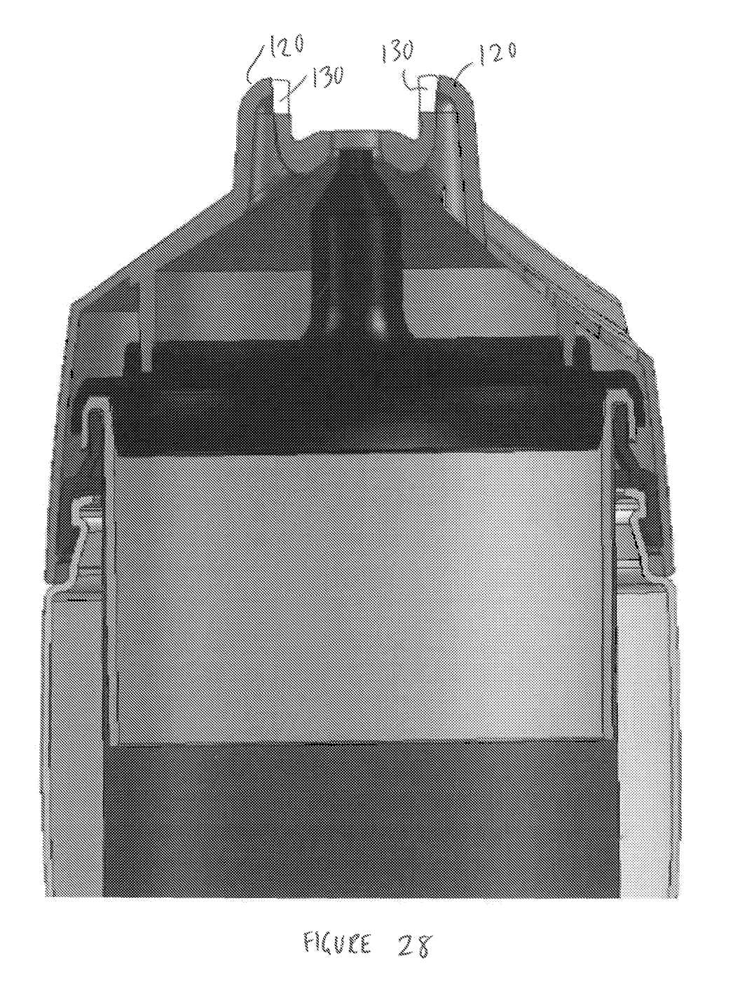

FIG. 30 is a perspective view of part of the an alternative sprayer,

FIG. 30A is a front schematic view of the sprayer of FIG. 24,

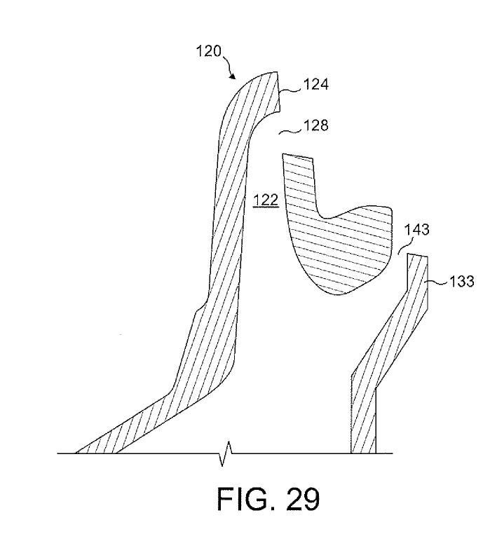

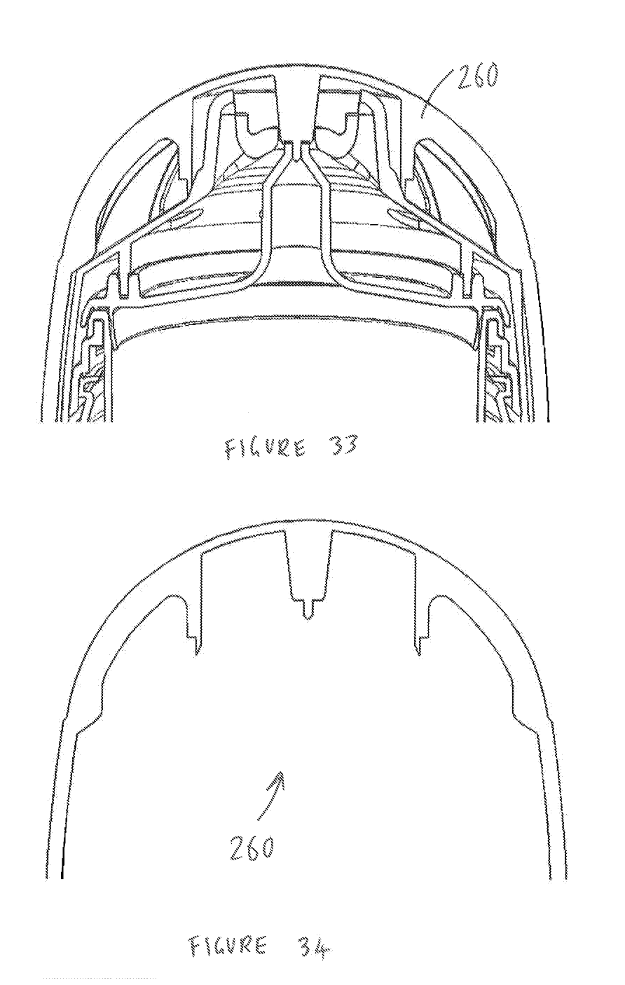

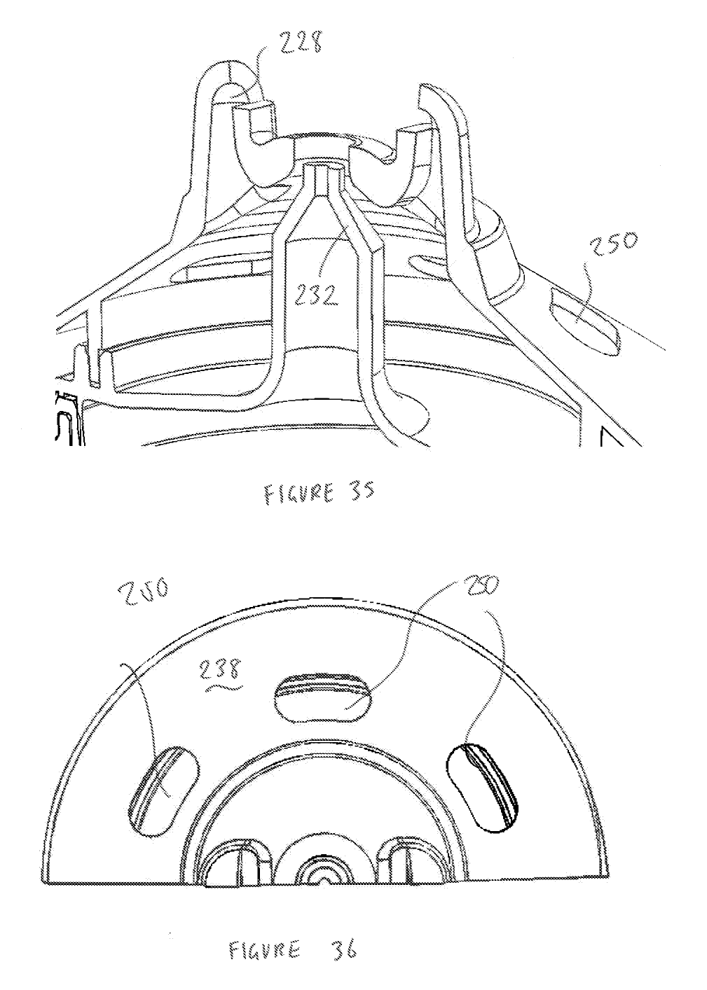

FIGS. 31 to 37 are front sectional views of part of the sprayer of FIG. 24,

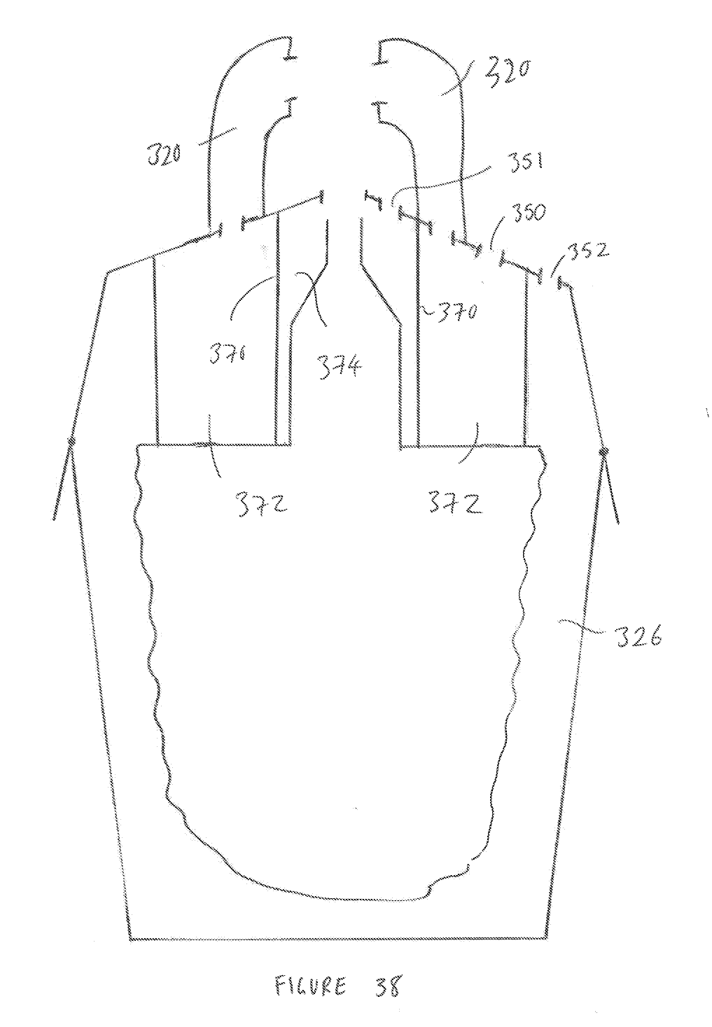

FIG. 38 is a front schematic view of an alternative sprayer, and

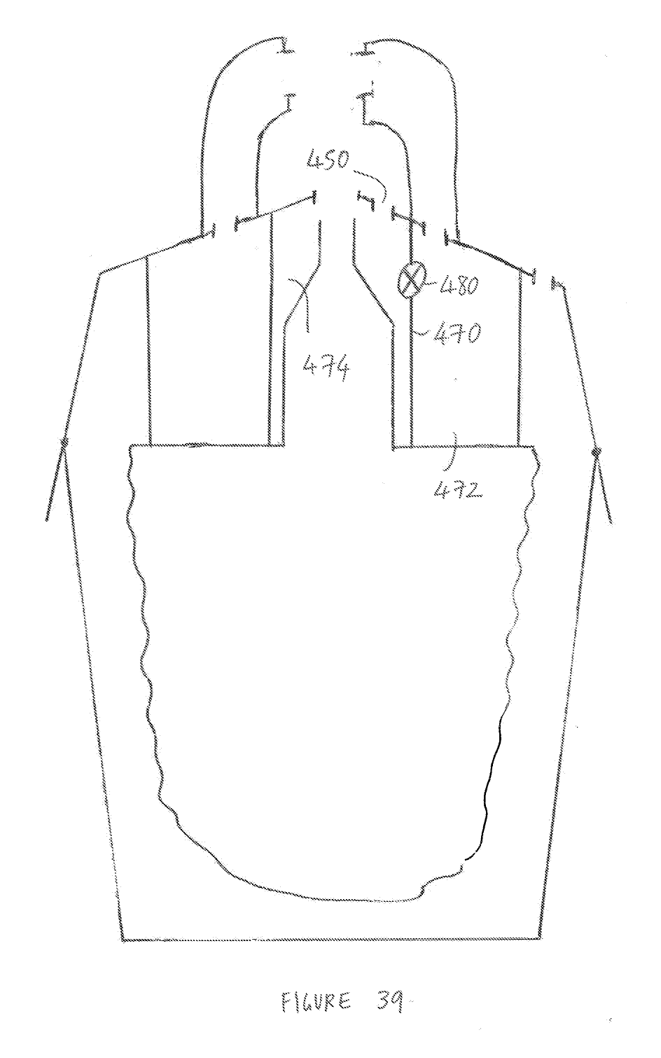

FIG. 39 is a front schematic view of an alternative sprayer.

With reference to FIGS. 1 to 23 there is shown a high volume low pressure paint sprayer 10.

The paint sprayer 10 comprises a base unit 12, a spray gun 14, and a paint canister 15 (FIG. 1).

The base unit 12 comprises a fan 13 (shown schematically as a dotted line in FIG. 1), powered by a power unit (not shown). The fan can supply air at a rate of 50 m³/hr.

The base unit 12 is connected to the spray gun 14 by an air hose 17.

The base unit 12 includes a switch 21 which operates the fan to supply an air flow to the spray gun 14 via hose 17.

The base unit 12 includes a recess 23 which partially receives and supports the spray gun 14 when not in use.

The spray gun 14 comprises a housing 20 which releasably receives the paint canister 15. The spray gun includes a trigger 19 (FIG. 2).

The housing 20 on the spray gun 14 has a front face 69.

The spray gun 14 optionally includes a shaping shroud 71 which is releasable attached to the front face 69 of the housing 20 (only shown in FIG. 1A).

The paint canister 15 comprises a rigid outer container 22 and a flexible bag 24 (FIGS. 3 and 17).

A second air chamber 26 is defined between the flexible bag 24 and the rigid outer container 22.

A paint chamber 28 is defined inside the flexible bag 24 and contains paint 29.

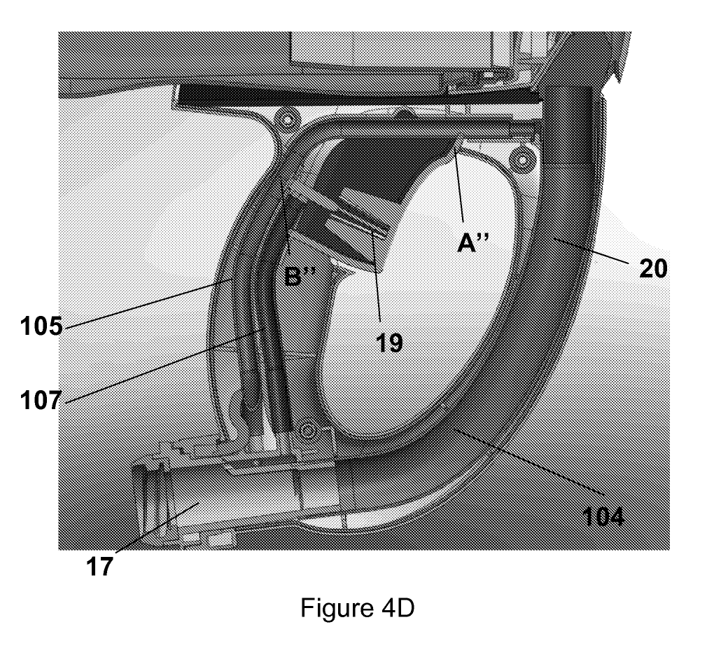

The paint canister 15 includes a paint nozzle module 30 which includes an integral paint nozzle 32 (FIGS. 4 and 8).

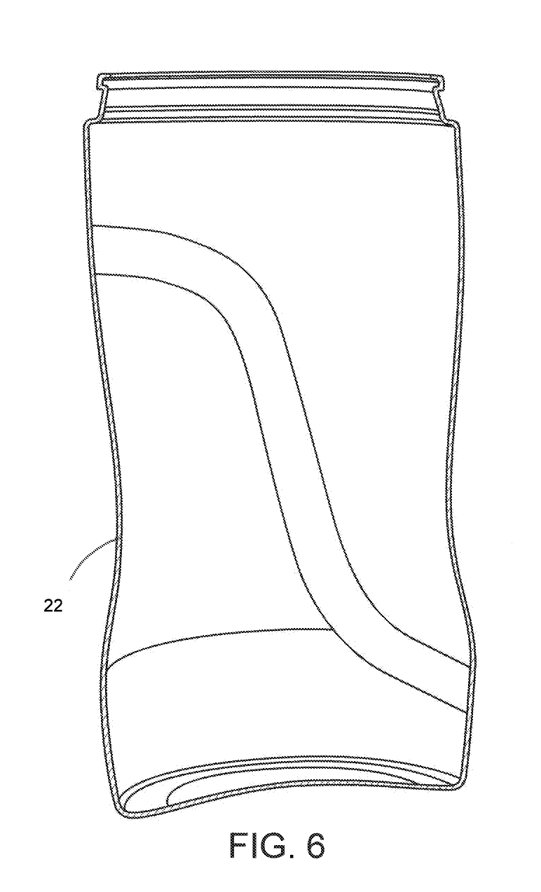

The paint sprayer 10 includes an air manifold 38 (FIG. 10).

The canister includes a fixing collar 34 which has a plurality of through apertures 36 (FIGS. 18 and 19). The fixing collar 34 has an upper section 35 (FIGS. 7 and 17), and an outer surface 96.

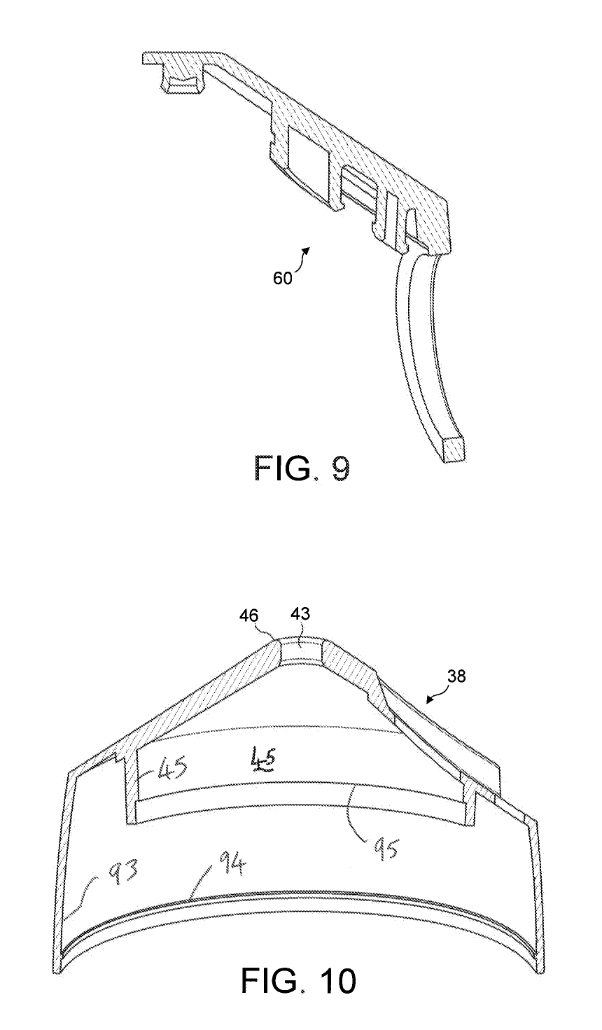

The flexible bag 24 is adhered to an outer surface 45 of an internal collar 42 which locates inside the bag and extends away from an opening 25 of the bag towards the base a distance Y sufficient to prevent the base of the flexible bag from collapsing when deforming (FIGS. 12 and 17). Typically the distance Y is between 10% and 50% of the length L of the flexible bag. In this embodiment L is 160 mm and Y is 70 mm.

The rigid internal collar 42 has an inverted J-shaped lip 43 which defines a recess 37.

The paint nozzle module 30 includes an upwardly projecting cylindrical wall 47 having a recess 49 and an upper surface 53 (FIG. 8).

The paint nozzle module 30 has a recess 90 (FIG. 8).

The paint nozzle 32 includes a paint flow face 44 (FIG. 8).

The paint nozzle 32 is cylindrical with a lower cylindrical section 101 (internal diameter 8.2 mm) and an upper cylindrical section 102, the two sections being joined by a tapered section 103. The lower section 103 has a diameter less than that of the upper section (FIG. 4).

Air interaction between the tapered section 103 and the air manifold 38 creates a venturi affect which assists in the paint atomisation.

The upper cylindrical section 102 includes a through outlet 33 (internal diameter 1.4 mm). There are no valve components in the through outlet 33 to restrict the paint flow.

The air manifold 38 includes a first air inlet 50 and a second air inlet 52, both air inlets being supplied with air from the base unit 12 via the air hose 17.

The air manifold 38 has an internal surface 93 with an inwardly projecting lip 94, and a downwardly projecting cylindrical wall 45 with a lower ledge 95 (FIG. 10).

The air manifold 38 includes an atomising air outlet 43 (internal diameter 6 mm) with an air flow face 46 (FIG. 10).

The paint canister 15 is assembled as follows:

The upper section 35 of the fixing collar 34 is inserted into the recess 37 of the rigid internal collar 42, the fit between the fixing and internal collars being an interference fit to form a subassembly 49 (shown assembled in FIGS. 14A and B).

The subassembly 49 then snap-fits onto the rigid outer container 22 via snap-fit inward projection 81 on the fixing collar 34, and outward projection 83 on the container 22 (FIG. 17) to form an open canister assembly 92 (FIG. 14). The fit between the subassembly and the fixing collar ensures no air can escape from the second air chamber.

It will be appreciated that the snap-fit engagement between the subassembly of rigid collar 42 and the outer container 43 enables the removal of the outer container 22 containing the flexible bag 24. This enables the flexible bag to be removed from the outer container which is advantageous if the flexible bag itself needs to be replaced as opposed to the completer canister including the rigid outer container.

The paint nozzle module 30 is secured to the open canister assembly 92 by location of the J-shaped lip 43 of the internal projection 42 with the recess 90 so as to form a paint tight seal to prevent paint from leaking from the paint chamber 28. The module 30 can be secured to the internal projection 42 using a screw fit, or an interference fit, or any other fit which creates a paint tight seal, and allows the nozzle module to be removed to enable the bag to be filled with paint. The ease of removal is important if the bag is to be filled in-store for example.

The air manifold 38 is secured to the paint nozzle module 30 by location of the downwardly projection cylindrical wall 45 inside recess 49 of the paint nozzle module 30 with sealing contact between the wall 45 and the recess 49, and further sealing contact between ledge 95 and the upper surface 53 (FIGS. 4 and 8). The seals formed between the paint nozzle module and the air manifold are air tight seals.

The air manifold 38 also forms an air tight seal with the rigid collar 34 by contact between the internal surface 93 and the external surface 95 and snap-fit engagement between ledge 94 and the snap-fit projection 81 (FIG. 17).

It can be seen from FIG. 4 that the rigid internal collar 42 and the fixing collar 34 are distinct components with the flexible bag 24 sandwiched therebetween so as to form a seal. In an alternative embodiment both collars could be provided as one single component as shown in FIG. 15 with the flexible bag sealed in between using a suitable adhesive.

Once assembled, the downwardly projection cylindrical wall 45 locates inside the recess 49 of the upwardly projecting cylindrical wall 47 to define a first air chamber 40 (FIG. 4).

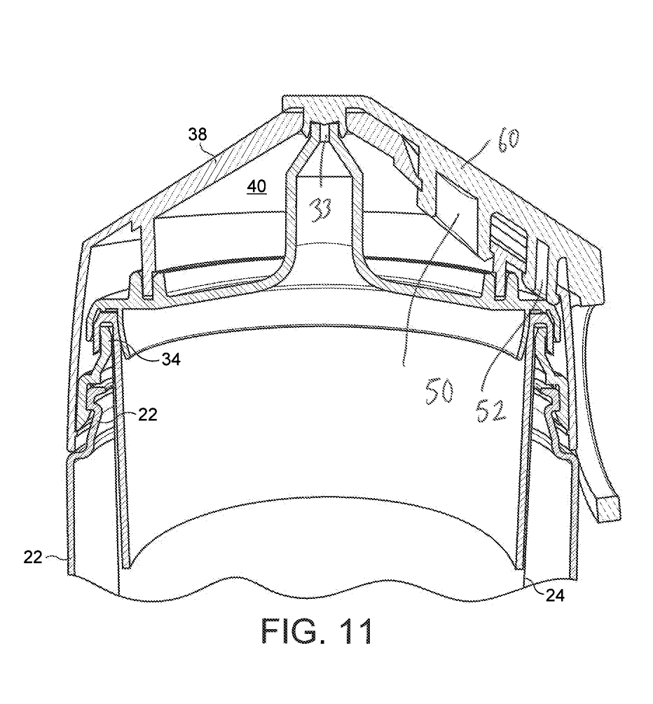

Once the paint nozzle module and the air manifold are assembled, the paint flow face 44, and the air flow face 46 are offset by a vertical distance X (FIG. 13), this distance typically being in the order of 2 mm, with an acceptable tolerance of ±0.2 mm.

The offset between the air flow face 46 and the paint flow face 44 increases the atomisation of the paint.

The air flow face 46 and the lower air flow face 46′ have a radius which assists atomisation of the paint.

All of the above components of the paint canister are moulded from plastic, for example polypropylene. The flexible bag is made from polyethylene.

The spray gun housing 20 includes a first internal tube 105, a second internal tube 104, and a vent tube 107 (vent tube only shown in FIGS. 4B to 4D). All three tubes are supplied with air from the fan 13 via house 17 (FIGS. 1 and 4A to 4D).

When the paint canister 15 is inserted into the spray gun housing 20, both tubes are arranged inside the front face 69 of the spray gun 20 such that first tube 104 locates against the first air inlet 50 of the air manifold 38 such a seal is formed allowing air to flow into the first atomising chamber 40 (FIGS. 1, 4 and 4A), and the second tube 105 locates against the second air inlet 52 such that a seal is formed allowing air to flow into the second paint chamber 26 (FIGS. 3 and 4A). This can be seen schematically in FIG. 23. A sealing material 39 is optionally included inside the front face 69 of the spray gun 20 to ensure an air tight seal is formed between the front face 69 and the air manifold 38. thereby ensuring no air escapes from the tubes before they reach the first and second air chambers.

Vent tube 107 does not need to seal against the canister and merely vents to atmospheric pressure inside the housing 20.

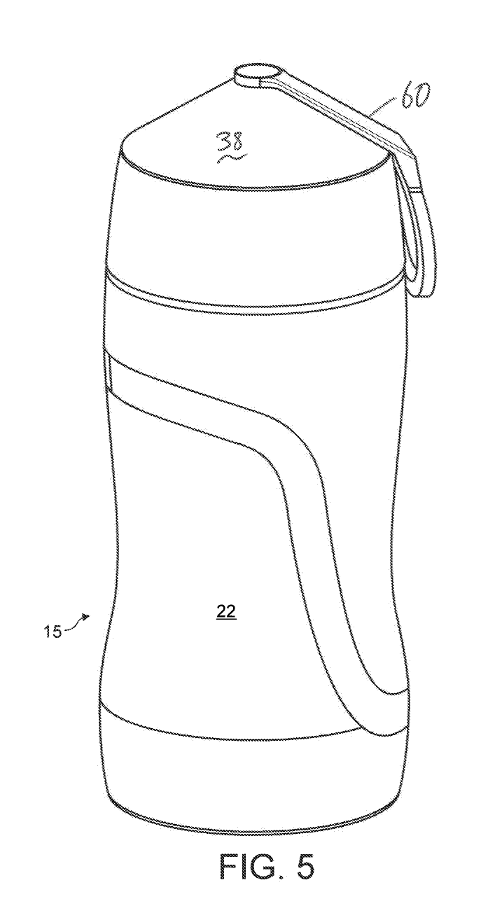

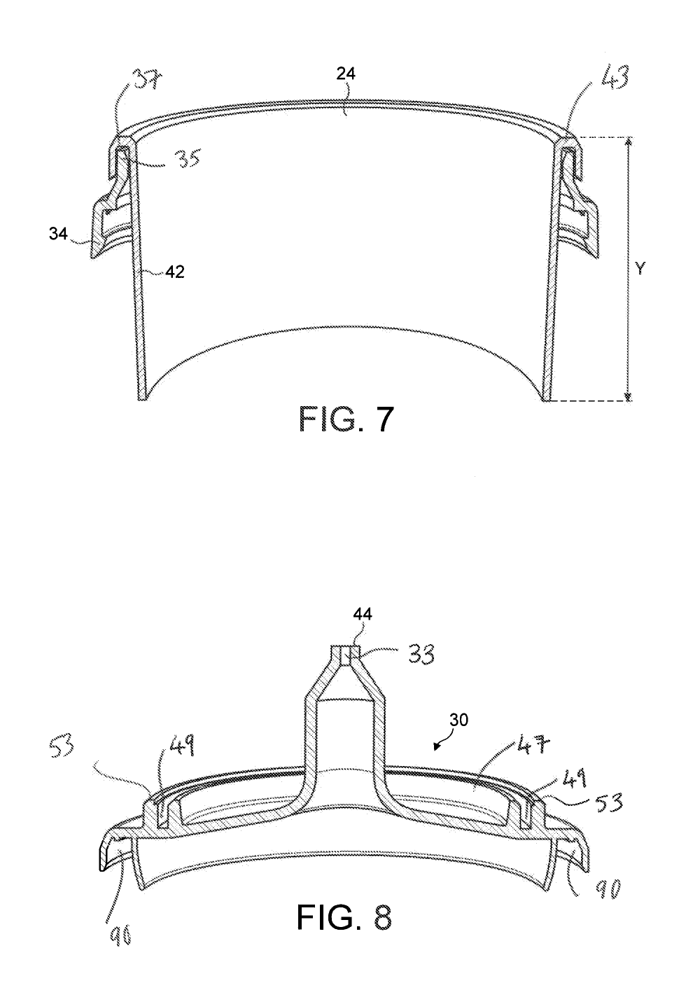

The air manifold 38 further includes a cap 60 (FIG. 9) which is releasably attachable to the air manifold 38 so as to block off the paint outlet 33 and the air outlet, and also the first and second air inlets 50,52 (FIG. 11).

The paint sprayer 10 operates as follows.

Switch 21 is depressed to provide air to hose 17 which in turn supplies air to the first 50 and second 52 air inlets via tubes 104,105.

Valve 84 is operated via the trigger 19 to allow air into the second air chamber 26 (indicated by arrow AF₂) via through apertures 36 (FIGS. 4, 14, 18, and 19).

Trigger 19 is connected to the valve 84 (which in this case is simply a means to crimp the tube to prevent air flow) which is positioned in the second tube 105 such that depression of the tube causes the valve to open (in this case causes the tube 105 to uncrimp), and air to flow to into the second paint chamber 40, thereby deforming the flexible bag 24 to cause paint flow.

FIG. 4B shows trigger 19 in an open position (the default position) which crimps tube 105 (at position A) preventing air flow, and thereby preventing supply of air into the second air chamber. When trigger 19 is open, the air that would ordinarily have been supplied to tube 105 is vented to the atmosphere via tube 107 since tube 107 is not blocked (at position B).

FIG. 4C shows trigger 19 in a depressed position (the default position) which uncrimps tube 105 (at position A′) enabling air flow air into the second air chamber. When trigger 19 is depressed the vent tube 107 is now crimped (at position B′) which prevents air from venting to the atmosphere and maintains the pressure in the second air chamber

FIG. 4D shows the trigger 19 in an intermediate position (A″,B″) after it has been released but before being fully open. In this position air is vented to the atmosphere via tube 107.

It will be appreciated that the provision of the vent tube also ensures a constant air flow rate in tube 104 to supply the first air chamber.

It will be appreciated that the paint canister itself contains no actuable parts, these parts are part of the spray gun.

It will be appreciated that air is always flowing to air inlet 50 (which does not cause paint to flow), whereas it is depression of trigger 19 which causes air to enter air inlet 52 allowing the flexible bag in the second air chamber 26 to be pressurised, and the bag to deform to cause paint flow.

An optional dial (not shown) can be included between the fan 17 and the air inlet 52 so that the air flow rate, and hence the paint flow rate can be varied.

The first air inlet 50 is supplied with continuous air from the fan 17 once the switch 21 is depressed. Optionally the air flow from the fan can be deactivated when the spray gun 14 is housed within the recess 23 of the base unit 12.

Air supplied via air inlet 50 (indicated by arrow AF₁) enters the air chamber 40 and exits the chamber via air atomising air outlet 43 which surrounds the paint nozzle 32. The air exiting from the atomising air outlet 43 assists in the atomisation of the paint. A minimum air flow rate at the paint nozzle for paint atomisation is 7 m³/hr.

When trigger 19 is depressed the air in outer chamber 26 causes the flexible bag 24 to deform such that paint inside the bag flows towards the paint nozzle 32.

It can be seen that the paint nozzle 32 comprises a through aperture 33, noting that there are no mechanical components, such as a valve, in the aperture 33 to selectively prevent paint flow. Paint flow rate is entirely dependent on the air flow rate provided by the controllable fan.

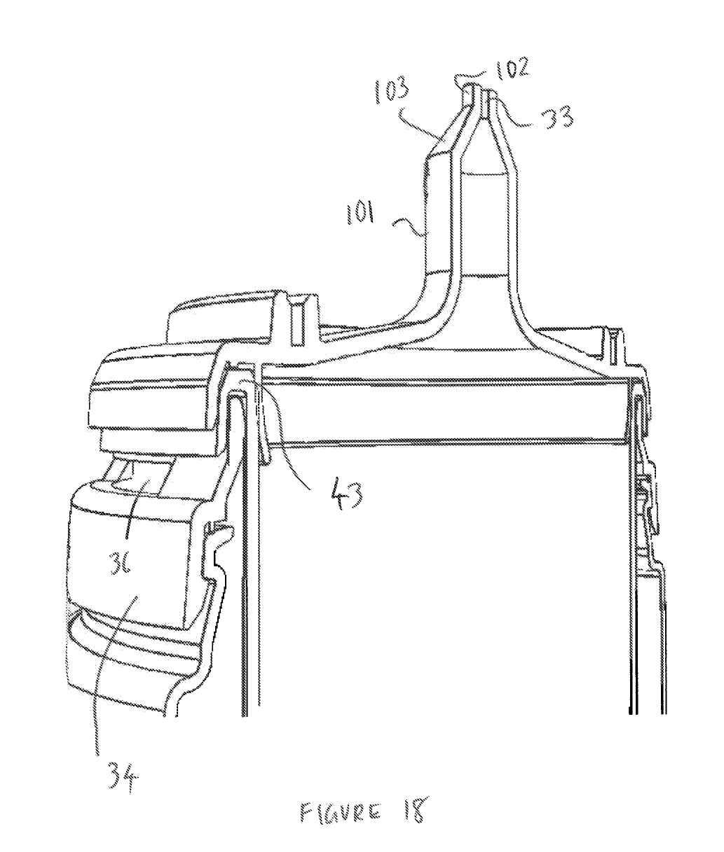

The paint exits the paint nozzle 32 via through outlet 33 whereupon it is atomised by air exiting the atomising air outlet 43, and then propelled towards a target (not shown) (FIGS. 13 and 22). The air exiting from outlet 43 is referred to as atomising air.

As the bag deforms, the provision of the rigid internal collar 42 forces the side walls 29 of the bag to roll onto each other like a diaphragm (FIGS. 12 and 12A) where it can be seen that the base 29 remains intact as opposed to the base collapsing. This controls the deformation of the bag and prevents an uncontrolled collapse which would otherwise cause a variable paint flow rate and potential spattering. Previously this problem has been mitigated by the use of pleated side walls which gives some control to the collapse of the bag.

Release of the trigger 19 stops the air flow to the second air inlet. Deactivation of switch 21 or housing the spray gun in the base unit turns of the fan off.

It will be appreciated that the paint flow rate is controlled by the air supply from the fan, there being no need for mechanical parts, such as a flow rate control valve, to come into contact with the paint.

Once the paint canister is empty, it can be disposed of. It will be understood that since only the paint canister comes into contact with paint there is no contamination of the spray gun parts.

FIG. 23 is a simplified version of the first air chamber 40, second air chamber 26, and the paint chamber 28, and shows how these are defined by the rigid outer wall 22 of the paint canister, the air manifold 38, and the paint nozzle module 30, and supplied with air from tube 104 via inlet 52 into the second air chamber 126, and tube 105 via inlet 50 into the first air chamber 40. Paint exits the paint chamber 28 via through aperture 33, and atomising air exist the first paint chamber via atomising air outlet 43.

With reference to FIGS. 24 to 29 there is shown an alternative sprayer 110 which is identical to the sprayer of FIGS. 1 to 24 except that the air manifold 138 includes two horn-like projections 120. Each of the projections includes a through aperture 122 channels air from the first air chamber 140 into the paint exiting from the through aperture 133 of the paint outlet. Each channel defines a semi-circular shaping air outlet 128. This air is called shaping air. It is also believed that this shaping air assists in the atomisation of the paint.

Each of the horn-like projections 120 has a vertical face 124 (which includes the shaping air outlets 128) and a horizontal face 126. The through aperture 122 in each of the projections defines a curved path such that air exiting from the horn-like projections is at an angle to the horizontal. It is important that this air is at an angle rather than horizontal as it performs a shaping effect. Previously to provide such an angled shaping air would require an angled face rather than a vertical face, which would require complex tooling parts. The use of vertical and horizontal faces enables open and shut tooling to be used.

It will be appreciated that the embodiment of FIGS. 24 to 29 utilises the air from the fan to atomise the paint via the atomising air outlets 43, pressurise the bag to cause paint flow, and the additional step when compared to the embodiment of FIGS. 1 to 23, of shaping the air via the shaping air outlets 128.

In the embodiment of FIGS. 24 to 29 there is no means of preventing the shaping air from interacting with the paint flow except the provision of an optional cap 130 (shown in FIG. 28) which acts to block the shaping air from exiting the shaping air outlet. This provides means of switching off the shaping air without having to include moving parts inside the sprayer itself, for example, a valve inside the first air chamber which closes the shaping air aperture internally. Effectively, this embodiment behaves in the same way as that of FIGS. 1 to 23.

FIG. 30A is a simplified version of the first air chamber 140, second air chamber 126, and the paint chamber 128, showing how these are defined by the rigid outer wall 122 of the paint canister, the air manifold 138, and the paint nozzle module 130, and supplied with air from tube 104 via inlet 152 into the second air chamber 126, and tube 105 via inlet 150 into the first air chamber 140. Paint exits the paint chamber 129 via through aperture 133, atomising air exits the first paint chamber via atomising air outlet 143, and shaping air exits the first air chamber via shaping air outlet 129.

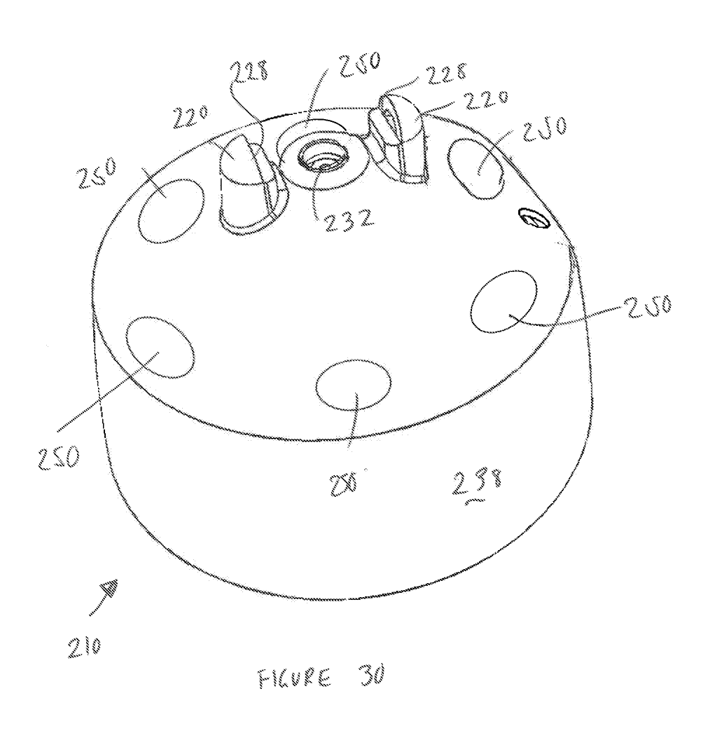

With reference to FIGS. 30 to 37 there is shown an alternative sprayer 210 which is identical to that of that of FIGS. 24 to 29 except that air manifold 238 utilises multiple first air inlets 250 rather than a single air inlet. The air inlets 250 are equally spaced around the paint nozzle 232 which balances up the shaping air exiting from shaping air outlets 228, and keeps it uniform. FIG. 32 shows the air manifold 238 without the paint nozzle module 230 in place.

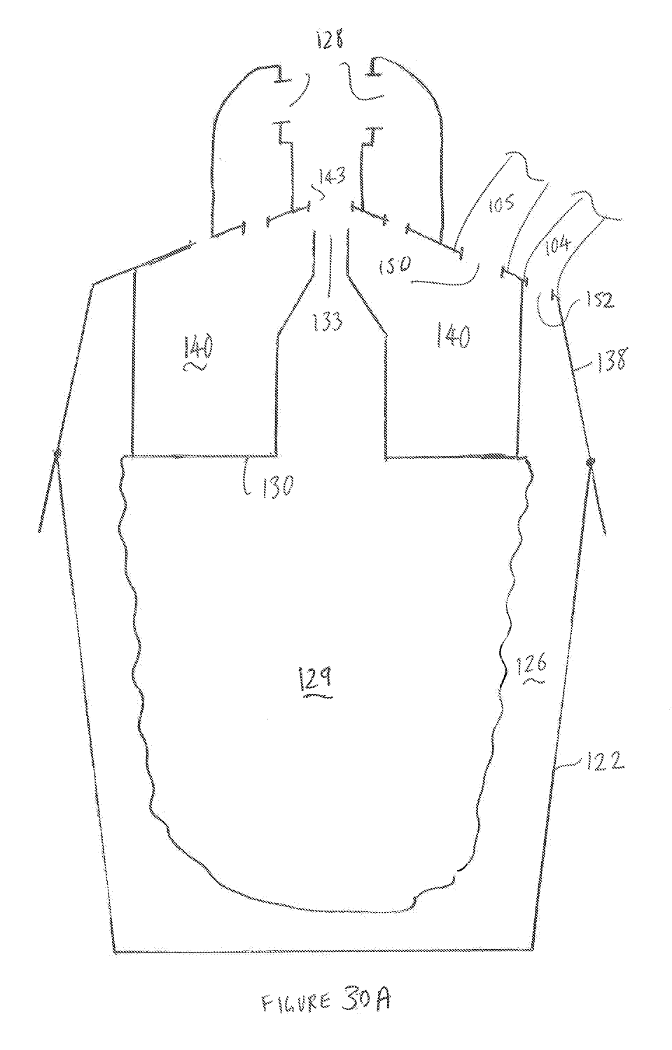

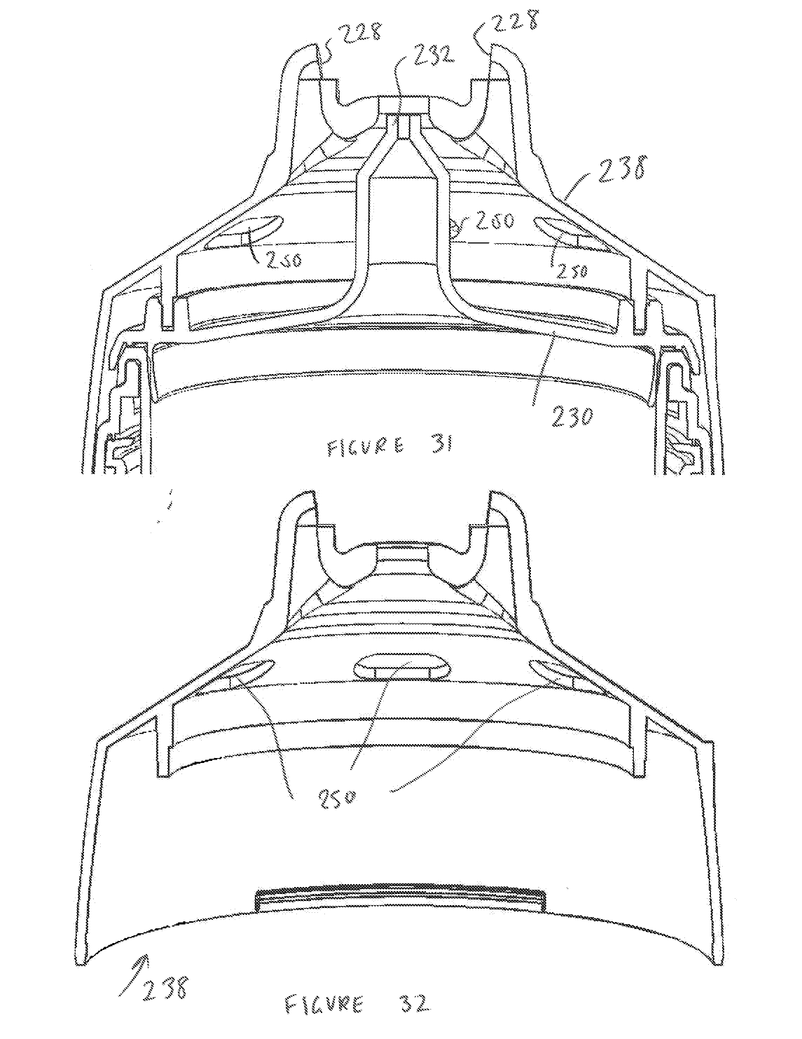

FIGS. 33 and 34 show the use of an alternative cap 260 to block the atomising and shaping air outlets, and paint outlet when the sprayer is not in use.

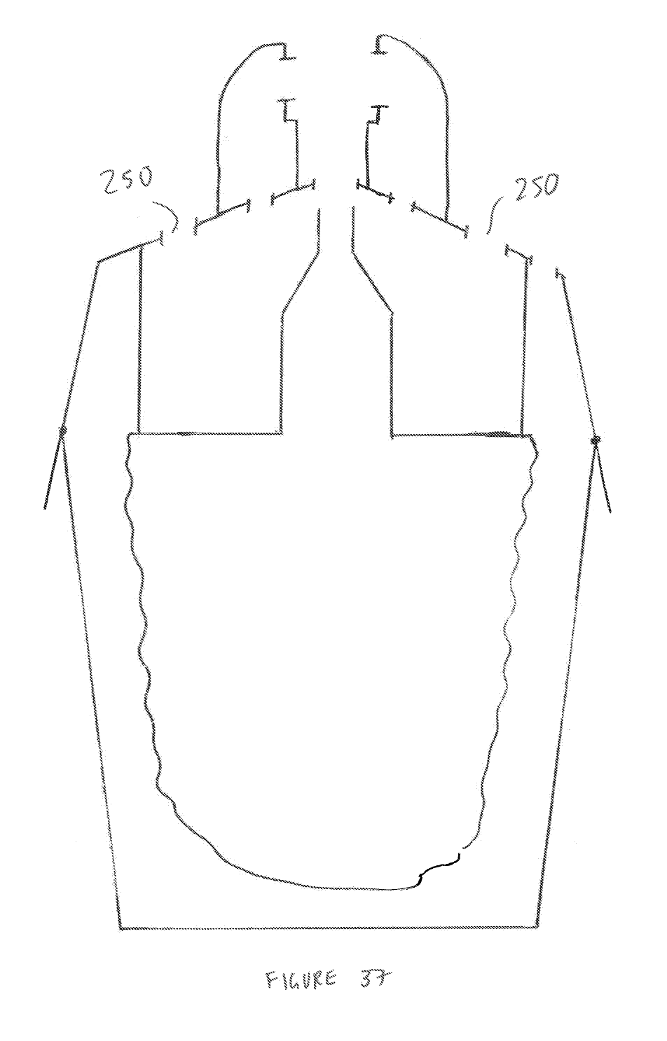

FIG. 37 is a simplified version of the modified air manifold of FIGS. 30 to 37, the difference from that of FIGS. 24 to 29 being the provision of the equally spaced air inlets 250.

FIG. 38 shows a modified sprayer in which a cylindrical dividing wall 370 splits the first air chamber into a shaping air chamber 372 and an atomising air chamber 374. Each of the air chambers is fed independently via inlets 350,351 which in turn are supplied by the fan. In the embodiment of FIG. 38, the air flow rates to inlet 51 can be altered the inclusion of a valve (not shown) which enables the shaping air to be switched off. Inlet 352 is fed in the same way as in the previous embodiments.

FIG. 39 shows a modified sprayer which is identical to that of FIG. 38 except that a valve 480 is included in the dividing wall which acts to allow air to enter the shaping air chamber 472 from the atomising air chamber 474 to selectively switch on shaping air since there is no independent air supply to the shaping air chamber.

In the embodiments of FIGS. 38 and 39, a single air inlet 350,351 or inlet 450 is provided (in the same way as the embodiment of FIGS. 24 to 29). Alternatively, equally spaced air inlets can be provided to the atomising air chamber and/or the shaping air chamber as defined in previous embodiments.

It should be noted that there is less of a requirement to balance the atomising air by utilising equally spaced air inlets than there is for balancing the shaping air.

Referring back to FIG. 1A, the shroud 71 has the effect of channelling the shaping air (produced via the horn like projections) to produce a spray pattern defined by the profile of the shroud. It can be seen from FIG. 1A that the profile is an elliptical one. This can be circular, or any other convenient shape. It can also be oriented to be horizontal (as in FIG. 1A) or vertical depending on the user requirement.

It can be seen from FIGS. 5 and 12 that the paint canister 15 has an upper end proximate the air manifold 38, and a lower end proximate the base 27. Feeding air into the manifold at the upper end provides more stable bag deformation which gives a more uniform flow rate and hence a reduction in paint spattering.

1. A high volume low pressure paint sprayer comprising a paint spray gun and a releasable paint canister, wherein the paint canister has an integrated paint spray nozzle.

2. The sprayer according to claim 1 wherein the paint canister comprises a rigid outer container defining a second air chamber, a flexible bag located inside the rigid outer container, and a paint nozzle module fluidly connected to the flexible bag, wherein the flexible bag is releasably attachable to the paint nozzle module.

3. A high volume low pressure paint sprayer comprising a paint spray gun, a paint canister, and an air supply, wherein the paint canister has a nozzle with a paint outlet, wherein the air supply to the paint canister causes paint to flow from the paint canister via the paint outlet, wherein the paint outlet is permanently open.

4. A high volume low pressure paint sprayer comprising a paint spray gun, a paint canister, and an air supply, wherein the paint canister has a nozzle with a paint outlet, the paint canister comprising a rigid outer container defining a second air chamber, and a flexible bag defining a paint chamber containing paint, wherein the flexible bag is fluidly connected to the paint outlet such that the air supply to the second air chamber causes the flexible bag to deform and force paint towards the paint outlet.

5. The sprayer according to claim 4 wherein the paint canister includes a rigid internal collar which locates inside the flexible bag and extends away from an opening of the bag a distance sufficient to prevent the base of the flexible bag from collapsing when the bag deforms.

6. The sprayer according to claim 5 wherein the rigid internal collar has a length between 10 to 50% of the length of the flexible bag.

7. The sprayer according to claim 4, wherein the air supply supplies air to a first air chamber of the paint canister via a first air inlet, the first air chamber having an atomising air outlet which at least partially surrounds the paint outlet, such that atomising air exiting the atomising air outlet at least partially atomises the paint being propelled from the paint outlet.

8. The sprayer according to claim 7 wherein the air supply supplies air to the second air chamber via a second air inlet.

9. The sprayer according to claim 8 further including an air manifold, wherein the air manifold includes the first and second air inlets.

10. The sprayer according to claim 4, wherein the flexible bag includes a fixing collar which is releasably attachable to the rigid outer container.

11. The paint sprayer according to claim 10 wherein the fixing collar includes at least one aperture to permit air flow into the second air chamber.

12. A high volume low pressure paint sprayer including a nozzle with a paint outlet, and an atomising air outlet which partially surrounds the paint outlet, the paint outlet having a paint flow face, and the air outlet having an air flow face, wherein the air flow face is vertically above and offset from the paint flow face.

13. The sprayer according to claim 12 wherein the air flow face has an at least partially circular profile.

14. A high volume low pressure paint sprayer comprising a paint spray gun, a paint canister, and an air supply, the paint canister having a nozzle with a paint outlet, wherein the air supply to the paint canister causes paint to flow from the paint canister via the paint outlet, and supplies air to an atomising air outlet which at least partially surrounds the paint outlet so as to at least partially atomise the paint being propelled from the paint outlet.

15. The sprayer according to claim 14 wherein the air supply is releasably coupled to an air manifold which is attached to the paint canister, the air manifold having a first air inlet which supplies air to the atomising air outlet, and a second air inlet, which supplies air to the paint canister to cause the paint to flow.

16. The sprayer according to claim 15 wherein the air manifold is releasably attachable to the paint canister.

17. The sprayer according to claim 14, wherein the air supply further supplies air to a shaping air outlet which is downstream of the atomising air outlet.

18. The sprayer according to claim 17 wherein the shaping air outlet lies in a substantially vertical plane.

19. The sprayer according to claim 17 wherein the shaping air outlet is integral with the air manifold.

20. The sprayer according to claim 17, wherein the shaping air outlet is supplied with air via a partially curved profile through aperture such that shaping air exiting from the outlet is angled relative to the horizontal.

21. The sprayer according to claim 15, wherein the paint nozzle is provided on a paint nozzle module, and the first air chamber is defined inbetween the paint nozzle module and the air manifold.

22. A high volume low pressure paint sprayer comprising a paint spray gun, a paint canister having a flexible bag with a base, and an air supply, the paint canister having a nozzle with a paint outlet, the paint canister having an upper end located proximate an air manifold, and a lower end proximate the base of the flexible bag, wherein the air supply to the paint canister is fed to the upper end of the paint canister.

23. (canceled)
